(19) United States
(12) Patent Application Publication
(10) Pub. No.: US 2002/0160808 A1
(43) Pub. Date: Oct. 31, 2002

(54) Mobile radio apparatus

(76) Inventors: Keiji Uehara, Tokyo (JP); Toshiaki Takaoka, Tokyo (JP); Koichi Ito, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/926,079

(22) PCT Filed: Dec. 26, 2000
(86) PCT No.: PCT/JP00/09259

(30) Foreign Application Priority Data
Dec. 27, 1999 (JP) 11-371764

(51) Int. Cl. H04B 1/38

(52) U.S. Cl. 455/558; 455/575

(57) ABSTRACT

Either a first memory card (13) for storing subscriber's information indispensable for communication, such as information on contract with a communication carrier or information to identify the user as a subscriber or a second memory card (15) for mainly storing application programs is selectively connected to a mobile radio apparatus. When the second memory card is installed, a main control unit (16) transfers the subscriber's information stored in the first memory card to the second memory card. Based on the subscriber's information, the main control unit receives the incoming call signal from a base station and informs notice of an incoming call. To speak by telephone, the second memory card is replaced with the first memory card, which makes it possible to talk over the telephone. Therefore, it is possible to provide an expandable mobile radio apparatus that enables functions to be added at the user's request.

### TECHNICAL FIELD

This invention relates to a mobile radio apparatus used in a mobile radio communication system, and more particularly to a mobile radio apparatus used in such a mobile radio communication system as a portable telephone system or PHS (Personal Handyphone System).

### BACKGROUND ART

In conventional mobile radio apparatus in Japan and the United States of America, subscriber's information and information on application programs have been stored in their built-in memory. In changing the subscriber's information, a communication carrier have rewritten the subscriber's information stored in the memory.

In conventional mobile radio apparatus by the GSM (global system for mobile communication) system in Europe, subscriber's information and information necessary for communication control have been stored in a removable IC (integrated circuit) card. On the other hand, such information as application programs and application data may be stored in their built-in memory as in the conventional mobile radio apparatus in Japan and the United States of America.

In recent years, as mobile radio apparatus have more and more functions, capacity of a memory installed has increased, resulting in a substantial increase in manufacturing cost of mobile radio apparatus. In the future, the memory will have to store a much larger data, such as image data. For this reason, users using old models have to buy new expensive mobile radio apparatus, when they want to use new functions usable only on new models or new services.

On the other hand, there are users who do not need those new functions or new services. It seems expensive to such users to install a large-capacity memory. In addition, buying a new mobile radio apparatus with many functions requiring complex operation results in unnecessary expenditure for the user.

From the user's viewpoint, a problem is to provide no mobile radio apparatus satisfying needs of users. On the other hand, from the manufacture's viewpoint, manufacturing various mobile radio apparatus impairs the effect of mass production and leads to a rise in a price of the mobile radio apparatus.

As described above, since it is difficult to manufacture conventional mobile radio apparatus in compliance with the needs of various users, a problem arises; users cannot buy mobile radio apparatus that satisfy their needs. In addition, there is another problem: users cannot help buying expensive mobile radio apparatus that have too many functions and are complex in operation or buying new ones each time new service is started.

### DISCLOSURE OF INVENTION

It is, accordingly, an object of the present invention to overcome the above problems by providing a highly expandable mobile radio apparatus that enables the user to add a function in compliance with the needs of users.

The foregoing object is accomplished by providing a mobile radio apparatus in a mobile radio communication system, comprising:

first interface means for connecting first storing means storing information including subscriber's information for communication with the mobile radio communication system; and

second interface means for connecting second storing means storing an application program executable on the mobile radio apparatus.

The mobile radio apparatus with the above configuration has interfaces to which storing means complying with two different standards can be connected. The storing means storing information in compliance with the needs of users can be selectively connected to the interfaces.

The mobile radio apparatus constructed as described above has such high expandability. Therefore, the user can make functions of the mobile radio apparatus more sophisticated or cause the apparatus to have only the necessary functions by just replacing the memory means without buying a new mobile radio apparatus.

### BRIEF DESCRIPTION OF DRAWINGS

FIG. 1 is a functional block diagram showing the configuration of a mobile radio apparatus according to a first embodiment of the present invention;

FIG. 2A shows how a first memory card is inserted into a first interface shown in FIG. 1;

FIG. 2B shows how a second memory card is inserted into a second interface shown in FIG. 1;

FIG. 3 is a flowchart to help explain the operation when the second memory card is inserted into the body in place of the first memory card to execute an application program stored in the second memory card of FIG. 1 and the operation when an incoming call occurs at that time;

FIG. 4 is a flowchart obtained by adding steps for changing an operation of informing notice of an incoming call by referring to the remaining number of incoming calls to the operation at the occurrence of an incoming call shown in FIG. 3;

FIG. 5 shows an example of shape of the first memory card and second memory card shown in FIG. 1;

FIG. 6A is a front view of the mobile radio apparatus of FIG. 1, showing how the first and second memory cards are installed in and removed from the side of the apparatus;

FIG. 6B is a bottom view of the mobile radio apparatus of FIG. 1, showing how the first and second memory cards are installed in and removed from two sides of the apparatus;

FIG. 7A is a rear view of the mobile radio apparatus, showing how the first memory card is installed in and removed from the back of the apparatus and further installed in and removed from one side of the second memory card;

FIG. 7B is a bottom view of the mobile radio apparatus, showing how the first memory card is installed in and removed from the back of the apparatus and further installed in and removed from one side of the second memory card;

FIG. 8A is a top view of an example of the first and second memory cards of FIG. 1 inserted into a connector;

FIG. 8B is a top view of a manner of inserting the first and second memory cards of FIG. 1 into a connector;

FIG. 8C is a side view of FIG. 8B; and

FIG. 8D is a sectional view taken along dashed arrows in FIG. 8A, showing how the first memory card is inserted into the connector.

### BEST MODE FOR CARRYING OUT OF THE INVENTION

Hereinafter, referring to the accompanying drawings, embodiments of the present invention will be explained.

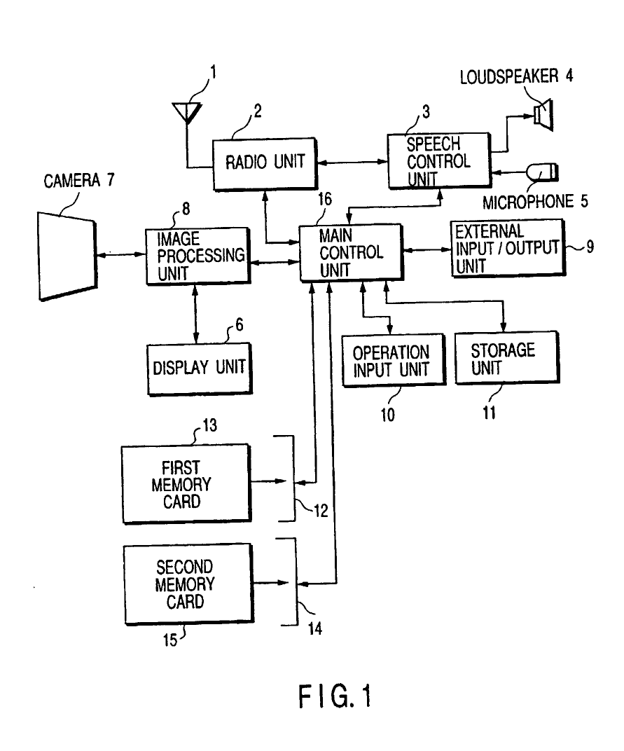

FIG. 1 is a functional block diagram showing the configuration of a mobile radio apparatus according to a first embodiment of the present invention.

A radio unit 2 transmits and receives a radio high-frequency signal via an antenna 1 to and from a base station (not shown) of a communication carrier connectable to a public telecommunication network. Specifically, the received radio high-frequency signal is down-converted and this down-converted signal is outputted to a speech control unit 3 explained later. At the same time, a transmission signal inputted from the speech control unit 3 is up-converted into a radio high-frequency signal, which is emitted from the antenna 1 to space and transmitted to a base station.

The speech control unit 3 encodes the transmitting speech signal inputted from a microphone 5 by a predetermined method for speech coding. In addition, the speech control unit 3 modulates this encoded signal into a transmission signal, which is outputted to the radio unit 2. A received signal inputted from the radio unit 2 is demodulated into a received speech signal, which is amplified and outputted from a loudspeaker 4.

An image processing unit 8 subjects an image signal picked up by a camera 7 using a solid-state imaging device composed of a CCD (charge-coupled device) or CMOS (complementary metal-oxide semiconductor) to an image process, such as encoding. By the image process, image data is obtained. The image data is converted into a form suitable for communication and resulting data is outputted to a main control unit 16.

At the same time, the image processing unit 8 decodes the image data received by the radio unit 2 or the image data stored in a storage unit 11 and the decoded data is displayed on a display unit 6, such as an LCD (liquid crystal display).

An external input and output unit (external input/output unit) 9 is an interface that connects an information apparatus, and inputs and outputs data.

An operation input unit 10 is a key input unit composed of calculator keys, cursor keys, and various function keys. The operation input unit 10 is used for not only ordinary outgoing and incoming calls but also the scrolling of the information displayed on the display unit 6, and instructions to the communication apparatus.

The storage unit 11 is composed of a semiconductor memory, such as a RAM (random-access memory) or a ROM (read-only memory). The storage unit 11 stores a control program for the main control unit 16 explained later. It also stores telephone directory data, redial data, and data on incoming calls during absence. In addition, it temporarily stores subscriber's information, including information on contract between the subscriber and the communication carrier and information to identify a specific user as a subscriber.

An interface 12 connects with a first memory card 13 electrically.

The first memory card 13 is an IC card used in, for example, GSM. In the first memory 13, subscriber's information indispensable for communication, including information on contract between the subscriber and the communication carrier and information to identify the user as a subscriber, is stored.

An interface 14 connects with the second memory card 15 electrically.

The second memory card 15 is larger in size than the first memory card 13 and has a large storage capacity. In the memory card 15, application programs executable on the main control unit 16 explained later and others are stored. The second memory card 15 may be SD (Secure Disk) card.

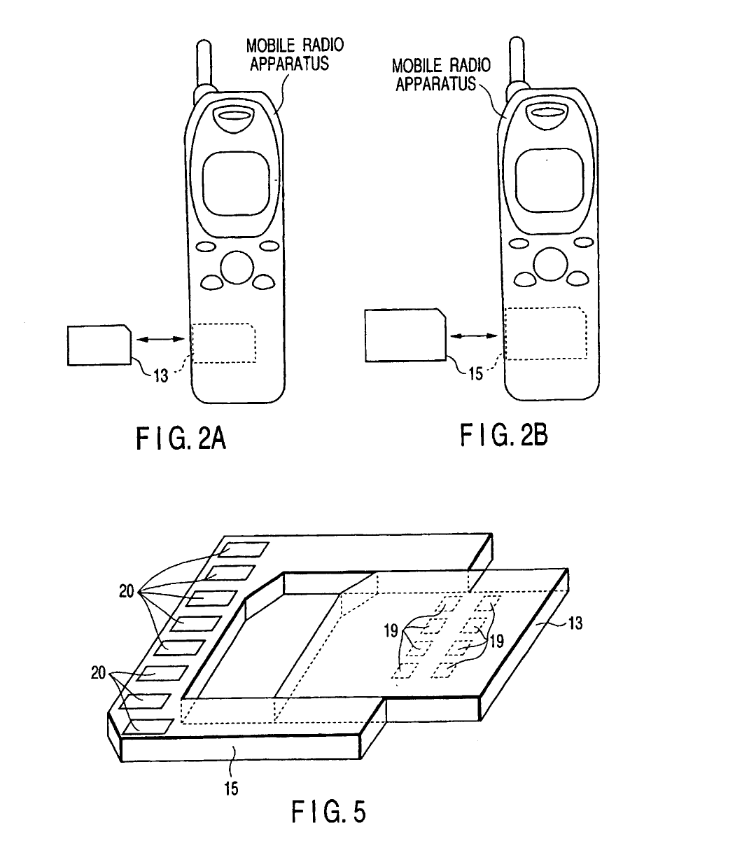

Either the first memory card 13 or second memory card 15 can be inserted into a card slot provided on, for example, one side of the mobile radio apparatus as shown in FIG. 2A and FIG. 2B. FIG. 2A shows how the first memory card 13 is inserted into the first interface 12 of FIG. 1. FIG. 2B shows how the second memory card 15 is inserted into the second interface 14 of FIG. 1. When these memory cards (13 and 15) are inserted into the card slots, the corresponding interfaces (12 and 14) are connected electrically with the mobile radio apparatus.

The main control unit 16 supervises control of each unit of the mobile radio apparatus. In control related to radio communication, control related to outgoing and incoming calls and speech is implemented on the basis of the information stored in the first memory card 13.

The main control unit 16 exchanges the image data transmitted and received at the radio unit 2 with the image processing unit 8. In addition, the main control unit 16 implements the application programs stored in the second memory card 15.

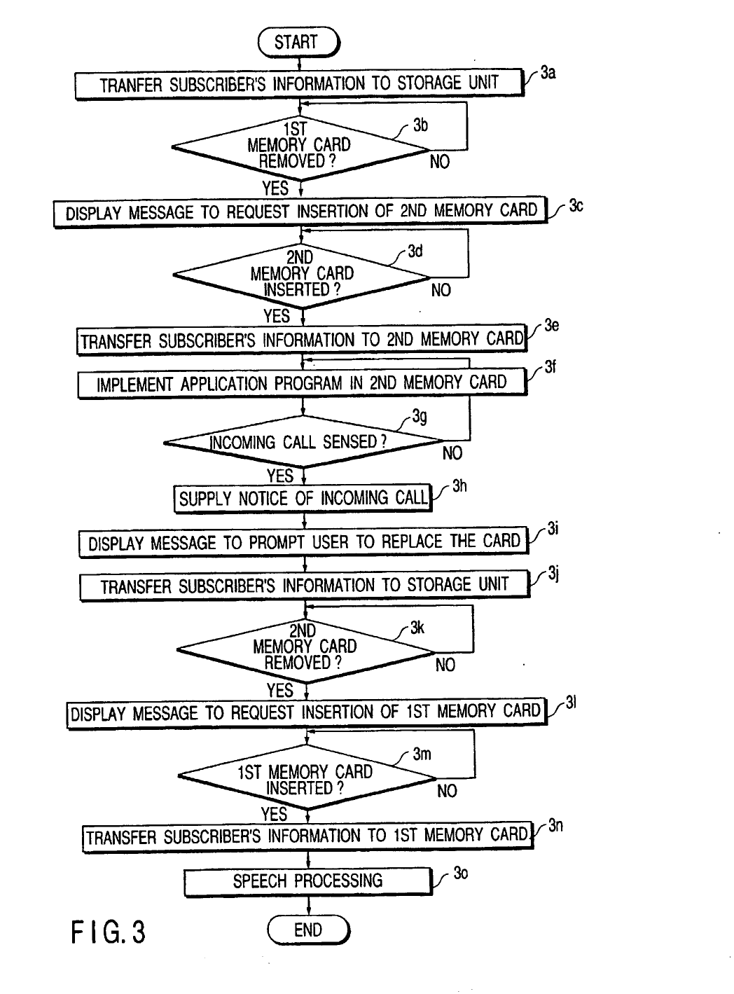

The following is an explanation of the operation in a case where, to implement the application programs stored in the second memory card 15, the second memory card 15 is inserted into the body in place of the first memory card 13 and connected to the interface 14 in the mobile radio apparatus with the above configuration, and an explanation of the operation when an incoming call occurs at a time of inserting the second memory card 15. FIG. 3 is a flowchart to help explain the operations. The operations of FIG. 3 are carried out by the main control unit 16.

With the first memory card 13 inserted into the mobile radio apparatus and connected to the interface 12, when the user requests the mobile radio apparatus to remove the first memory card 13, the process shown in FIG. 3 is started.

At a step 3a, necessary information for incoming call control, including the subscriber's information stored in the first memory card 13, is transferred to the storage unit 11. The subscriber's information is stored in the storage unit 11. After the storing is completed, the message showing that the memory card can be removed, such as “MEMORY CARD CAN BE REMOVED,” appears via the image processing unit 8 on the display unit 6. Then, the step of this process proceeds to a step 3b.

At a step 3b, it is decided whether the first memory card 13 inserted into the card slot is removed. If it is decided that the first memory card 13 has been already removed, the step of this process proceeds to a step 3c. If not, the step of this process goes to a step 3b again. Then, the step of this process is in the wait state until the first memory card 13 is removed.

At a step 3c, a message to prompt the user to insert the second memory card 15, such as “INSERT SECOND MEMORY CARD,” appears via the image processing unit 8 on the display unit 6. Then, the step of this process proceeds to a step 3d.

At a step 3d, it is decided whether the second memory card 15 is inserted into the card slot. If it is decided that the second memory card 15 has been already inserted, the step of this process proceeds to a step 3e. If not, the step of this process goes to a step 3d again. Then, the step of this process is in the wait state until the second memory card 15 is inserted.

At a step 3e, the necessary information for incoming call control, including the subscriber's information stored in the storage unit 11, is transferred to the second memory card 15. The subscriber's information is then stored in the second memory card 15. After the storing is completed, the mobile radio apparatus exchanges the necessary information for location registration with the base station on the basis of the subscriber's information stored in the second memory card 15, thereby enabling the mobile radio apparatus to receive an incoming call from a mobile radio communication system. Then, the step of this process proceeds to a step 3f.

At a step 3f, the application program in the second memory card is implemented. Then, the step of this process proceeds to a step 3g.

At a step 3g, the occurrence of an incoming call is monitored using the subscriber's information transferred to the second memory card 15 at a step 3e. If the occurrence of an incoming call is sensed, the step of this process proceeds to a step 3h. If the occurrence of an incoming call is not sensed, the step of this process returns to a step 3f, where the implementation of the application program is continued.

At a step 3h, a message to inform an incoming call to the user appears via the image processing unit 8 on the display unit 6. At the same time, the loudspeaker 4 produces sound to notify an incoming call to the user, and the step of this process proceeds to a step 3i. The notification of an incoming call is continued until a step 3o.

At a step 3i, a message to prompt the user to replace the memory card inserted into the card slot with the first memory card 13, such as “REPLACE THE CARD WITH FIRST MEMORY CARD,” appears via the image processing unit 8 on the display unit 6, and the step of this process proceeds to a step 3j.

At a step 3j, the subscriber's information stored in the second memory card 15 is transferred to the storage unit 11. The subscriber's information is stored in the storage unit 11. After the storing is completed, the message that the memory card can be removed, such as “MEMORY CARD CAN BE REMOVED,” appears via the image processing unit 8 on the display unit 6. Then, the step of this process proceeds to a step 3k.

At a step 3k, it is decided whether the second memory card 15 inserted into the card slot is removed. If it is decided that the second memory card 15 has been already removed, the step of this process proceeds to a step 3l. If not, the step of this process goes to a step 3k again, where the mobile radio apparatus is in the wait state until the second memory card 15 is removed.

At a step 3l, a message to prompt the user to insert the first memory card 13, such as “INSERT FIRST MEMORY CARD,” appears via the image processing unit 8 on the display unit 6, and the step of this process proceeds to a step 3m.

At a step 3m, it is decided whether the first memory card 13 is inserted into the card slot. If it is decided that the first memory card 13 has been already inserted, the step of this process proceeds to a step 3n. If not, the step of this process goes to a step 3m again, where the mobile radio apparatus is in the wait state until the first memory card 13 is inserted.

At a step 3n, the subscriber's information stored in the storage unit 11 is transferred to the first card memory 13. The subscriber's information is stored in the first memory card 13. After the storing is completed, the step of this process proceeds to a step 3o.

At a step 3o, the process of establishing a communication link is carried out according to a predetermined protocol in response to the incoming call occurred at a step 3g, which enables the user to speak by telephone. Then, this process is completed.

As described above, the mobile radio apparatus with the above configuration has the memory cards (13 and 15) complying with two different standards selectively housed therein. When the second memory card 15 for mainly implementing application programs is installed, the subscriber's information stored in the first memory card 13 is transferred to the second memory card 15.

Therefore, using the second memory card 15 enables the mobile radio apparatus with the above configuration to have a high expandability that makes it possible to add functions according to the user's request and to receive an incoming call even with the second memory card 15 installed. Using the first memory card 13 enables the user to speak through telephone in response to the incoming call.

With such a high expandability, a new function can be added by just replacing the second memory card 15 with the one storing a new application program. Therefore, the user need not buy the whole of a new mobile radio apparatus with a memory storing new application programs.

Because users who do not need many functions have only to get the second memory card 15 storing only basic application programs, it is possible to suppress useless expenditure.

Hereinafter, a mobile radio apparatus according to a second embodiment of the present invention will be explained. Because the configuration of the second embodiment is almost the same as that of the first embodiment, explanation will be described with concentrating on the points at which the second embodiment differs from the first embodiment.

In a mobile radio apparatus according to the second embodiment, the second memory card 15 stores not only the application programs but also number-of-incoming-calls limit information indicating the acceptable number of incoming calls. The main control unit 16 informs the user of an incoming call according to the number-of-incoming-calls information.

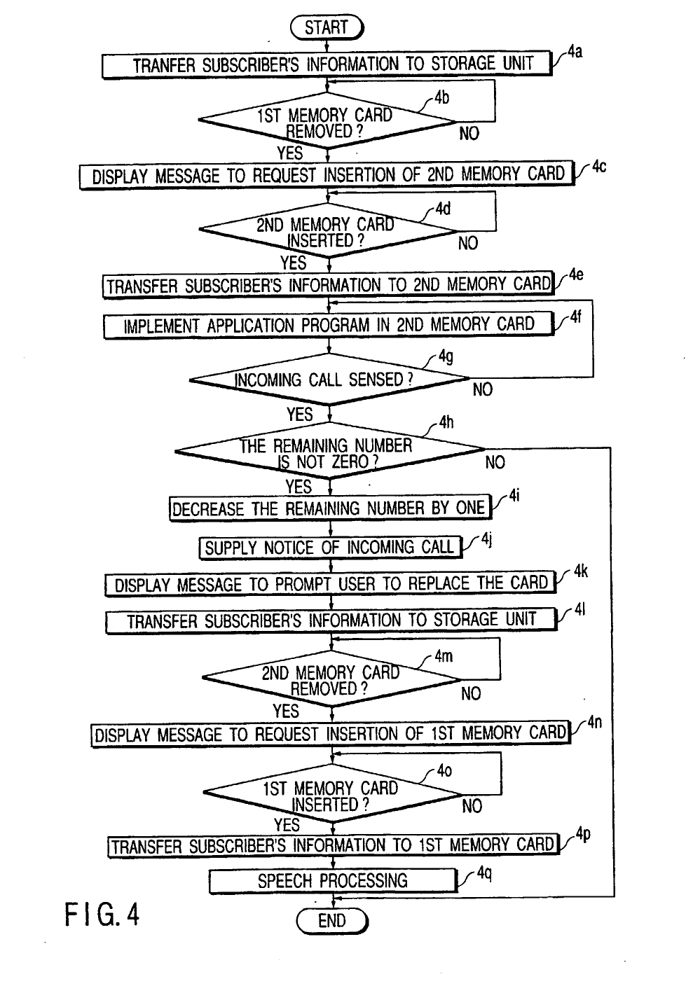

The following is an explanation of the operation in a case where the second memory card 15 is inserted into the body in place of the first memory card 13 to implement the application programs stored in the second memory card 15 and is connected to the interface 14, and an explanation of the operation when an incoming call occurs at a time of the insertion and the connection. FIG. 4 is a flowchart to help explain the operations. The operations of FIG. 4 are carried out by the main control unit 16.

With the first memory card 13 inserted into the mobile radio apparatus and connected to the interface 12, when the user requests the mobile radio apparatus to remove the first memory card 13, the processes shown in FIG. 4 are started.

At a step 4a, necessary information for incoming call control, including the subscriber's information stored in the first memory card 13, is transferred to the storage unit 11. The subscriber's information is stored in the storage unit 11. After the storing is completed, a message showing to enable the memory card to be removed, such as “MEMORY CARD CAN BE REMOVED,” appears via the image processing unit 8 on the display unit 6. Then, the step of this process proceeds to a step 4b.

At a step 4b, it is decided whether the first memory card 13 inserted into the card slot is removed. If it is decided that the first memory card is removed, the step of this process proceeds to a step 4c. If not, the step of this process goes to a step 4b again, where the mobile radio apparatus is in the wait state until the first memory card 13 is removed.

At a step 4c, a message to prompt the user to insert the second memory card 15, such as “INSERT SECOND MEMORY CARD,” appears via the image processing unit 8 on the display unit 6. Then, the step of this process proceeds to a step 4d.

At a step 4d, it is decided whether the second memory card 15 is inserted. If it is decided that the second memory card 15 has been already inserted, the step of this process proceeds to a step 4e. If not, the step of this process goes to a step 4d again, where the mobile radio apparatus is in the wait state until the second memory card 15 is inserted.

At a step 4e, the necessary information for incoming call control, including the subscriber's information stored in the storage unit 11, is transferred to the second memory card 15. The subscriber's information is stored in the second memory card 15. After the storing is completed, the mobile radio apparatus exchanges the necessary information for location registration with the base station on the basis of the subscriber's information stored in the second memory card 15, which enables an incoming call to be received from the a mobile radio communication system. Then, the step of this process proceeds to a step 4f.

At a step 4f, the application program in the second memory card is implemented. Then, the step of this process proceeds to a step 4g.

At a step 4g, the occurrence of an incoming call is monitored using the subscriber's information transferred to the second memory card 15 at a step 4e. If the occurrence of an incoming call is sensed, the step of this process proceeds to a step 4h. If the occurrence of an incoming call is not sensed, the step of this process returns to a step 4f, where the implementation of the application program is continued.

At a step 4h, the number-of-incoming-calls limit information stored in the second memory card 15 is referred to and it is decided what the remaining number of incoming calls is (or whether the remaining number of incoming calls is one or more). If the remaining number is one or more, the step of this process proceeds to a step 4i. In contrast, if the remaining number is 0, this process is ended and notice of an incoming call is not given.

At a step 4i, the number-of-incoming-calls limit information stored in the second memory card 15 is decreased by one, and the step of this process proceeds to a step 4j.

At a step 4j, a message to inform an incoming call to the user appears via the image processing unit 8 on the display unit 6 and simultaneously the loudspeaker 4 produces sound to inform an incoming call to the user. Then, the step of this process proceeds to a step 4k. The informing of the incoming call is continued until a step 4q explained later.

At a step 4k, a message to prompt the user to replace the memory card inserted into the card slot with the first memory card 13, such as “REPLACE THE CARD WITH FIRST MEMORY CARD,” appears via the image processing unit 8 on the display unit 6. Then, the step of this process proceeds to 4l.

At a step 4l, the necessary information for incoming call control, including the subscriber's information stored in the second memory card 15, is transferred to the storage unit 11. The subscriber's information is stored in the storage unit 11. After the storing is completed, a message to enable the memory card to be removed, such as “MEMORY CARD CAN BE REMOVED,” appears via the image processing unit 8 on the display unit 6. Then, the step of this process proceeds to a step 4m.

At a step 4m, it is decided whether the second memory card 15 inserted into the card slot is removed. If it is decided that the second memory card 15 has been already removed, the step of this process proceeds to a step 4n. If not, the step of this process goes to a step 4m again, where the mobile radio apparatus is in the wait state until the second memory card 15 is removed.

At a step 4n, a message to prompt the user to insert the first memory card 13, such as “INSERT FIRST MEMORY CARD,” appears via the image processing unit 8 on the display unit 6. Then, the step of this process proceeds to a step 4o.

At a step 4o, it is decided whether the first memory card 13 is inserted into the card shot. If it is decided that the first memory card 13 has been already inserted, the step of this process proceeds to a step 4p. If not, the step of this process goes to a step 4o again, where the mobile radio apparatus is in the wait state until the first memory card 13 is inserted.

At a step 4p, the necessary information for incoming call control, including the subscriber's information stored in the storage unit 11, is transferred to the first memory card 13. The necessary information for incoming call control, including the subscriber's information, is stored in the first memory card 13. After the storing is completed, the step of this process proceeds to a step 4q.

At a step 4q, the process of establishing a communication link is carried out according to a predetermined protocol in response to the incoming call occurred at a step 4g, which enables the user to speak through telephone. Then, this process is ended.

As described above, the mobile radio apparatus with the above configuration has the memory cards (13 and 15) complying with two different standards selectively housed therein. When the second memory card 15 for mainly implementing application programs is installed, the subscriber's information stored in the first memory card 13 is transferred to the second memory card 15 and an incoming call is accepted according to the limited number of accepted incoming calls stored in the second memory card 15.

Therefore, using the second memory card 15 enables the mobile radio apparatus with the above configuration to have a high expandability that makes it possible to add functions according to the user's request. In addition, even with the second memory card 15 installed, the mobile radio apparatus can receive incoming calls unless the limited number of incoming calls is exceeded. Replacing the second memory card with the first memory card 13 enables the user to speak through telephone in response to an incoming call.

The present invention is not limited to the above embodiments. While in the second embodiment, the user is informed of an incoming call unless the limited number of incoming calls is not exceeded, a time limit may be set and the user may be informed of an incoming call during only a preset period of time.

The installation of both the first memory card 13 and the second memory card 15 makes the mobile radio apparatus larger. To make the mobile radio apparatus smaller, the connectors to which the memory cards are connected may be formed into an integral structure. Moreover, using a single slot through which the memory cards are inserted into the body of the mobile radio apparatus makes the apparatus much smaller in size.

While in the above embodiments, either the first memory card 13 or the second memory card 15 is installed, both the first memory card 13 and the second memory card 15 may be install as shown in FIG. 5. FIG. 5 shows how the first memory card 13 engages with the inside of the second memory card.

Specifically, shape of the second memory card may be modified so that the first memory card 13 (with connection terminals 19) may engage with the inside of the second memory card 15 without modifying the dimensions of external shape of the second memory card 15 or without changing locations of the interface 14 and connection terminal 20. As a result, the first memory card 13 and second memory card 15 can be installed in the mobile radio apparatus at the same time.

The two memory cards (13 and 15) shown in FIG. 5 connect to a connector serving as connection means for these memory cards and can exchange information with the main control unit 16 in the mobile radio apparatus. The connector corresponds to the aforementioned interface.

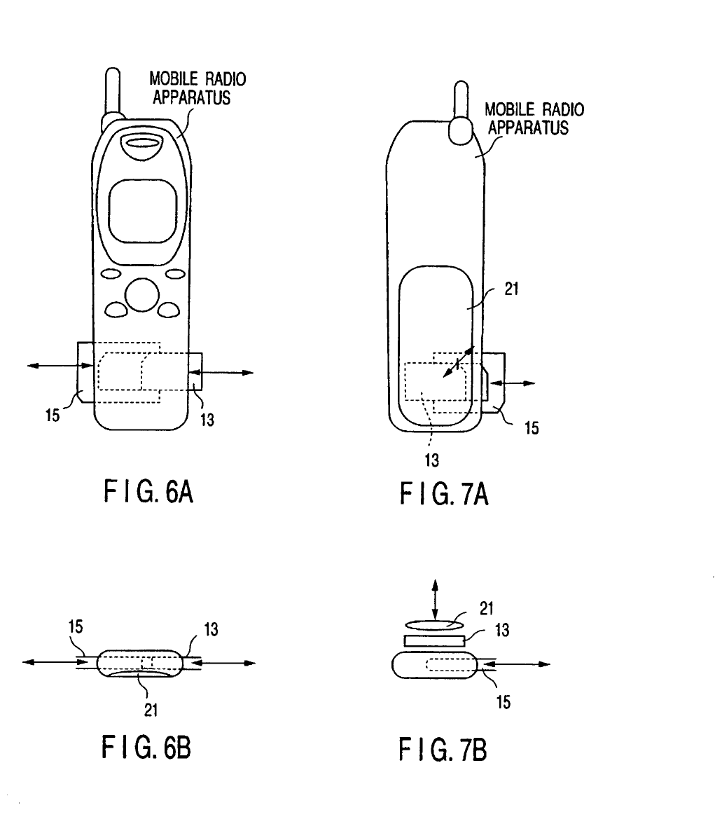

With such a configuration, as shown in FIGS. 6A and 6B, the first memory card 13 is inserted into the mobile radio apparatus from its left side and the second memory card 15 is inserted into the mobile radio apparatus from its right side, thereby this insertion causes these memories to engage with each other inside the apparatus. As a result, with the first memory card 13 installed, the second memory card 15 can be replaced.

Furthermore, as shown in FIGS. 7A and 7B, the mobile radio apparatus is so constructed that the first memory card 13 is installed in the mobile radio apparatus from inside space where the battery 21 is installed, the battery being removable from the back of the mobile radio apparatus, and the second memory card 15 is inserted into the mobile radio apparatus from its right side so that it engages with the first memory card 13 inside the mobile radio apparatus. As a result, the first memory card 13 indispensable for communication can be made difficult to remove, whereas the second memory card 15 can be replaced, regardless of the installation of the first memory card 13.

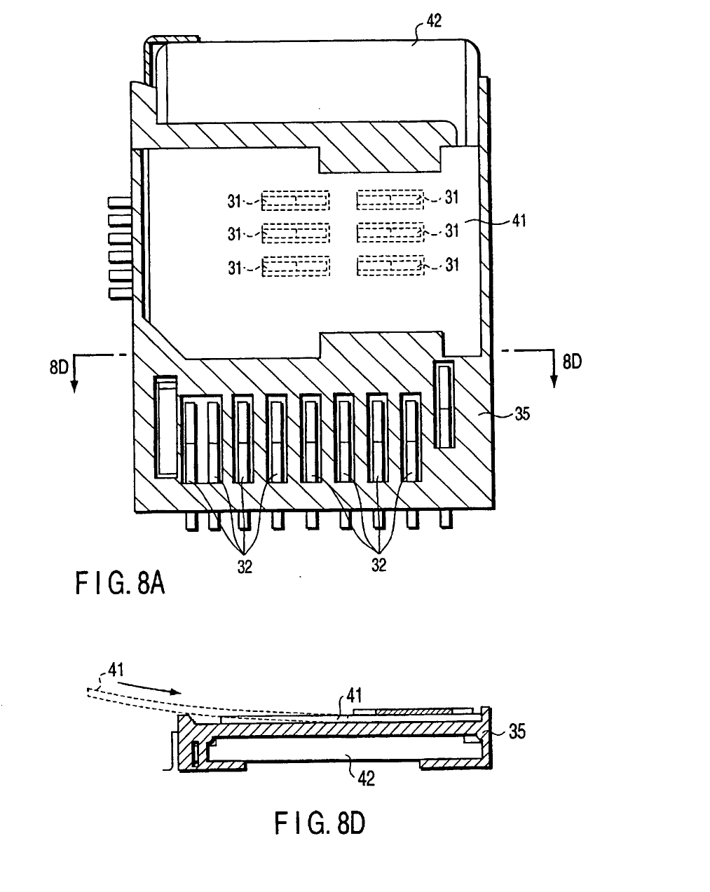

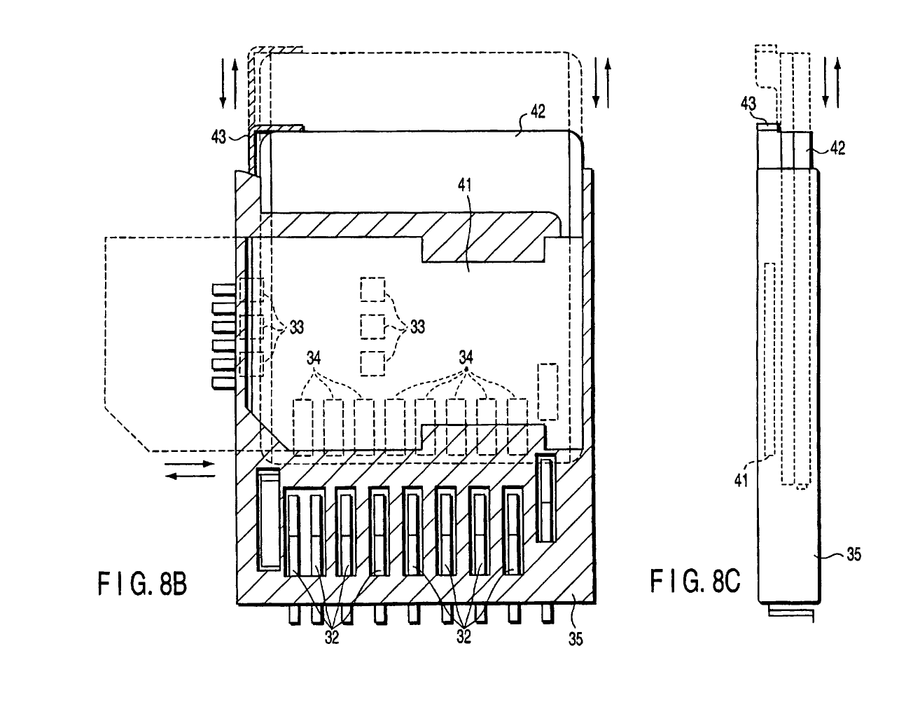

FIGS. 8A, 8B, 8C, and 8D show other modifications of the case where the memory cards are installed in the mobile radio apparatus. FIG. 8A is a top view of an example of the first and second memory cards of FIG. 1 inserted into a connector. The first and second memory cards shown in FIG. 8A are different from these shown in FIG. 5. Specifically, the second memory card is not shaped so that it engages with the first memory card. The second memory card of FIG. 8A is a flat card and does not have a shape into which the first memory card can be fitted. In addition, the number of terminals also differs from that of the memory card shown in FIG. 5. A connector 35 shown in FIG. 8A has connection terminals 31 for connecting with the first memory card 41 electrically and connection terminals 32 for connecting with the second memory card 42 electrically. The connector 35 of FIG. 8A enables the first memory card 41 and second memory card 42 to be connected to the single connector 35 as shown in FIG. 8A.

FIG. 8B is a top view of a manner of inserting the first memory card 41 and second memory card 42 of FIG. 1 into the connector 35. The arrows shown in FIG. 8B indicate the direction in which the first memory card 41 or second memory card 42 is inserted into or removed from the connector and the direction in which a slide bar 43 moves.

In FIG. 8B, the first memory card 41 is inserted into the connector 35 from the left side of the connector 35. On the underside of the first memory card 41, six connection terminals 33 are provided. These connection terminals 33 connect with the connection terminals 31 of the connector 35 shown in FIG. 8A, when the first memory card 41 is housed in the connector 35.

On the other hand, the second memory card 42 is inserted into the connector 35 from above in FIG. 8B. On the top surface of the second memory card 42, nine connection terminals 34 are provided. These connection terminals 34 connect with the connection terminals 32 of the connector 35, when the second memory card 42 is housed in the connector 35.

The following is explanation that is more detailed. First, the slide lever 43 is pulled out of the connector 35. Then, the end of the second memory card 42 is positioned at the guide unit of the connector 35, with the surface on which the connection terminals 34 of the second memory card 42 is provided facing upward. The second memory card 42 is inserted until the slide lever 43 comes into contact with the opposite end of the second memory card 42, the opposite end is opposite to the end setting about being inserted. Pushing the slide lever 43 causes the second memory card 42 to be inserted into the connector 35.

As described above, only the single connector 35 enables two memory cards (41 and 42) to be connected.

FIG. 8C is a side view of FIG. 8B. Figure showing the connector into which the memory cards are inserted, when viewed from the left side in FIG. 8C, is FIG. 8B. In FIG. 8C, the second memory card 42 is placed below the first memory card 41 within the connector 35. Then, part of the first memory card 41 is located at the upper part of the second memory card 42. In this memory card arrangement, the second memory card 42 can be replaced, with the first memory card 41 being installed.

FIG. 8D shows how the first memory card 41 is installed in the connector 35. FIG. 8D is a sectional view taken along dashed arrows in FIG. 8A. In FIG. 8D, the end of the first memory card 41 is placed at the guide unit of the connector 35, with the surface of the card 41 on which the connection terminals 33 are provided facing downward (or in the connector 35 side). Then, the first memory card 41 is slid in the direction shown by the arrow in FIG. 8D so that the memory card 41 approaches the connector 35, while the first memory card 41 is being pressed toward the connector 35. As a result, the first memory card 41 is installed in the connector 35. In FIG. 8D, the dotted lines of 41 show the first memory card 41 by the way of installation. On the other hand, the solid lines of 41 show the first memory card 41 installed).

This connector 35 is a housing connector shaped so that it encloses the outer surfaces of these two memory cards (41 and 42). The connection terminals (33 and 34) of the first memory card 41 and second memory card 42 respectively connect with the connection terminals (31 and 32) of the housing connector electrically. This enables information to be exchanged between the memory cards (41 and 42) and the main control unit 16.

Because it is presumed that the second memory card (15 or 42) should store a large amount of data, such as application programs as described above, it is desirable that the second memory card (15 or 42) should be a storage medium with a large capacity of, for example, 64 megabytes or more. The present invention, however, need not be restricted to such a storage medium.

Moreover, because it is presumed that the second memory card (15 or 42) should store application programs as described above, it is desirable from the viewpoint of copyright protection that it should be a storage medium with a copy protect function. This invention, however, need not be restricted to a storage medium with such a function.

Furthermore, the first memory card (13 or 41) and second memory card (15 or 42) may not be a mere storage medium but a storage medium with a central processing unit (CPU). The CPU enables, for example, a security function to be provided for the memory card.

As described above, the present invention includes an interface to which storing means complying with two different standards can be connected. The interface enables the storing means storing the information satisfying the user's needs to be selectively connected.

Therefore, with the present invention, because the mobile radio apparatus has a high expandability, it is possible to provide a mobile radio apparatus that enables the user to make the function of the apparatus more sophisticated or cause the apparatus to have only the necessary functions by just replacing the storing means without buying a new mobile radio apparatus.

Furthermore, the present invention may be practiced or embodied in still other ways without departing from the spirit or essential character thereof.

Industrial Applicability

As described above, the present invention is effective in the field of manufacturing mobile radio apparatus, the field of manufacturing memory cards inserted into mobile radio apparatus, and the field of developing or producing application programs run on mobile radio apparatus.

1. A mobile radio apparatus in a mobile radio communication system, comprising:
first interface means for connecting first storing means storing information including subscriber's information for communication with the mobile radio communication system; and
second interface means for connecting second storing means storing an application program executable on the mobile radio apparatus.

2. The mobile radio apparatus according to claim 1, further comprising incoming call control means for receiving an incoming call signal and for informing notice of an incoming call based on information necessary for incoming call control stored in the second storing means, in case that the second storing means is connected to said second interface means.

3. The mobile radio apparatus according to claim 2, further comprising speech control means for responding to an incoming call, establishing a communication link, and implementing speech control, in case that the first storing means is connected to said first interface means in a case where said incoming call control means informs notice of an incoming call.

4. The mobile radio apparatus according to claim 2, wherein said incoming call control means, when the number of incoming calls reaches a preset number, receives an incoming call signal based on the information necessary for incoming call control, and informs notice of an incoming call.

5. The mobile radio apparatus according to claim 2, wherein said incoming call control means, when the time of sensing a incoming call is a preset time, receives an incoming call signal based on the information necessary for incoming call control, and informs notice of an incoming call.

6. The mobile radio apparatus according to claim 1, wherein the information in the first storing means is transferred to the second storing means at the same time when the second storing means is inserted.

7. The mobile radio apparatus according to claim 1, wherein the information necessary for incoming call control includes information on a contract with a communication carrier and information to identify a user as a subscriber.

8. The mobile radio apparatus according to claim 1, wherein the first storing means and the said second storing means are removable

9. The mobile radio apparatus according to claim 1, further comprising:
third storing means for reading information necessary for incoming call control from said first storing means and storing the information, in case that the first storing means is connected to said first interface means;
transfer recording means for transferring and recording the information necessary for incoming call control stored in said third storing means to the second storing means, when the second storing means is connected to said second interface means; and
incoming call control means for receiving an incoming call signal and informing notice of an incoming call based on the information necessary for the incoming call control stored in the second storing means.

10. The mobile radio apparatus according to claim 1, further comprising connection means for connecting the first storing means and the second storing means, and serving as a single connector.

11. The mobile radio apparatus according to claim 10, wherein said connection means is a housing connector.

12. The mobile radio apparatus according to claim 10, wherein said connection means is the same slot provided on the apparatus.

13. The mobile radio apparatus according to claim 10, further comprising display means for displaying a message that the first storing means or the second storing means is to be removed from said connection means and the message that the first storing means or the second storing means is to be inserted into said connection means.

14. The mobile radio apparatus according to claim 10, wherein the second storing means has such a shape as houses the first storing means therein and becomes an integral structure with the first storing means without changing its external dimensions.

15. The mobile radio apparatus according to claim 10, wherein said first interface means and said second interface means are arranged in connectable locations, the first storing means and the second storing means being an integral structure.

16. The mobile radio apparatus according to claim 15, wherein the first storing means is inserted from one side of a frame on the connector and the second storing means is inserted from the other side of the frame.

17. The mobile radio apparatus according to claim 15, wherein either the first storing means or the second storing means is inserted from space for providing a battery.
